(19) United States
(12) Patent Application Publication
(10) Pub. No.: US 2007/0040335 A1
(43) Pub. Date: Feb. 22, 2007

(54) AXIALLY ADJUSTABLE SEALING RING

(75) Inventor: Mark William Kowalczyk, Amsterdam, NY (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/161,902

(22) Filed: Aug. 22, 2005

(51) Int. Cl. F16J 15/447

(52) U.S. Cl. 277/412

(57) ABSTRACT

A sealing ring for a turbine housing. The sealing ring may include a sealing face with a number of teeth thereon, an axial slot positioned within the sealing face, a head portion for positioning within the turbine housing, and a connector for attaching the sealing face to the head portion through the axial slot.

### TECHNICAL FIELD

The present invention relates generally to seals or packing rings used in rotating machinery such as turbines and, more particularly, relates to such seals or packing rings having the ability to be adjusted in the axial direction.

### BACKGROUND OF THE INVENTION

Rotary machines such as steam and gas turbines used for power generation and mechanical drive applications generally are large machines with multiple turbine stages. High-pressure fluid flows through these stages and must pass through a series of adjoining stationary and rotating components. Seals between the stationary and the rotating components are used to control fluid leakage.

More specifically, non-contacting packing ring labyrinth seals are typically used in machines of this type. The seals are designed to block the leakage flow along the rotor without actually touching the shaft. Such seals conventionally include a series (generally five or six) of packing or sealing rings disposed in annular grooves in the turbine casing. These rings typically include a number of spaced-apart teeth extending radially from the turbine casing towards the rotating shaft surface. The amount of clearance is largely determinative of the rate of leakage. The sealing function is achieved by creating a turbulent flow of a working media, for example, steam, as it passes through the relatively tight clearances within the labyrinth defined by the seal face teeth and the opposing surface of the rotating component.

The effectiveness of these seals is a major factor in determining the efficiency of the turbine, because leakage of steam through the seals results in a loss of work-producing energy. To maximize efficiency, customers often will plan on replacing the sealing rings during routine maintenance. The customer thus may have a complete set of spare rings on hand when they take apart a turbine. However, this type of maintenance can be complicated due to vibration of the shaft and distortions of the stationary components. This type of movement or distortion can cause the rings to touch or “rub” the rotating component, causing damage to the seal teeth. Axial rubs are the most damaging, because they cause the teeth to bend over to the side. When a customer opens up a machine and finds damage due to an axial rub, the customer cannot simply replace the seal with an identical part, as replacement with the same seal would only result in the teeth again being damaged. Instead, the customer may have to scrap the old part and order replacement parts. The resulting outage thus can cost the customer a significant amount in added costs and delays.

It should be recognized that turbine designers already take significant steps to minimize leakage and thereby improve turbine performance. Current seals are made of materials specially selected to minimize damage cause by rubbing. The seal geometry is designed with thin teeth that result in the least amount of heat and force during rubbing situations. The seal rings also can be designed to allow rubbing forces to shift the rings radially away from the shaft. The ability of a sealing ring to be adjusted in the radial direction can be achieved, for example, by the use of a spring-backed sealing ring.

Designers also may take steps to minimize the damage to the turbine seals during transition periods, such as when the turbine is accelerating or decelerating through its critical speeds or adjusting thermally. These systems allow for the radial clearance to be controlled, adjusted, or varied in response to changes in the operating conditions of the turbine.

One of the drawbacks with known sealing ring systems is that although the position of the seal may be adjusted in the radial direction, these systems do not currently have the ability to adjust sealing rings in the axial direction. As discussed previously, axial rubs may be the most damaging to the seals because they tend to bend the teeth over to the side. What may be desired, therefore, is a turbine system that allows for an individual set of sealing teeth to be adjusted quickly in the axial direction.

### SUMMARY OF THE INVENTION

The present application thus describes a sealing ring for a turbine housing. The sealing ring may include a sealing face with a number of teeth thereon, an axial slot positioned within the sealing face, a head portion for positioning within the turbine housing, and a connector for attaching the sealing face to the head portion through the axial slot.

The sealing ring may include a number of axial slots and a number of connectors. The connector may be a bolt. The connector also may be a clip. The sealing face and the head portion may include a number of grooves. The sealing face grooves may align with the head portion grooves. The sealing face may include a number of axial positions with respect to the head portion.

The present application further describes a sealing ring for a turbine housing. The sealing ring may include a sealing face with a number of teeth thereon, an axial slot positioned within the sealing face, a head portion for positioning within the turbine housing, and a bolt for attaching the sealing face to the head portion through the axial slot. The sealing face may include a number of axial positions with respect to the head portion.

The sealing ring may include a number of axial slots and a number of connectors. The sealing face and the head portion may include a number of grooves. The sealing face grooves may align with the head portion grooves.

The present application further describes a method for positioning a sealing ring having a sealing face and a head portion axially with respect to a turbine shaft. The method may include the steps of aligning the sealing face along the turbine shaft, attaching the sealing face to the head portion, and rotating the turbine shaft such that the sealing face does not contact the turbine shaft. The attaching step may include inserting a bolt through the sealing face and the head portion and/or inserting a clip into the sealing face and the head portion.

These and other features of the present invention will become apparent to one of ordinary skill in the art upon review of the following detailed description of the preferred embodiments when taken in conjunction with the drawings and appended claims.

### BRIEF DESCRIPTION OF THE DRAWINGS

FIG. 1 is a schematic view of a sealing ring segment as is described herein positioned adjacent to the shaft.

FIG. 2 is a perspective view of the sealing ring segment of FIG. 1.

FIG. 3 is a bottom perspective view of the sealing ring segment of FIG. 1.

FIG. 4 is a perspective view of an alternative embodiment showing a clip connection.

### DETAILED DESCRIPTION OF THE INVENTION

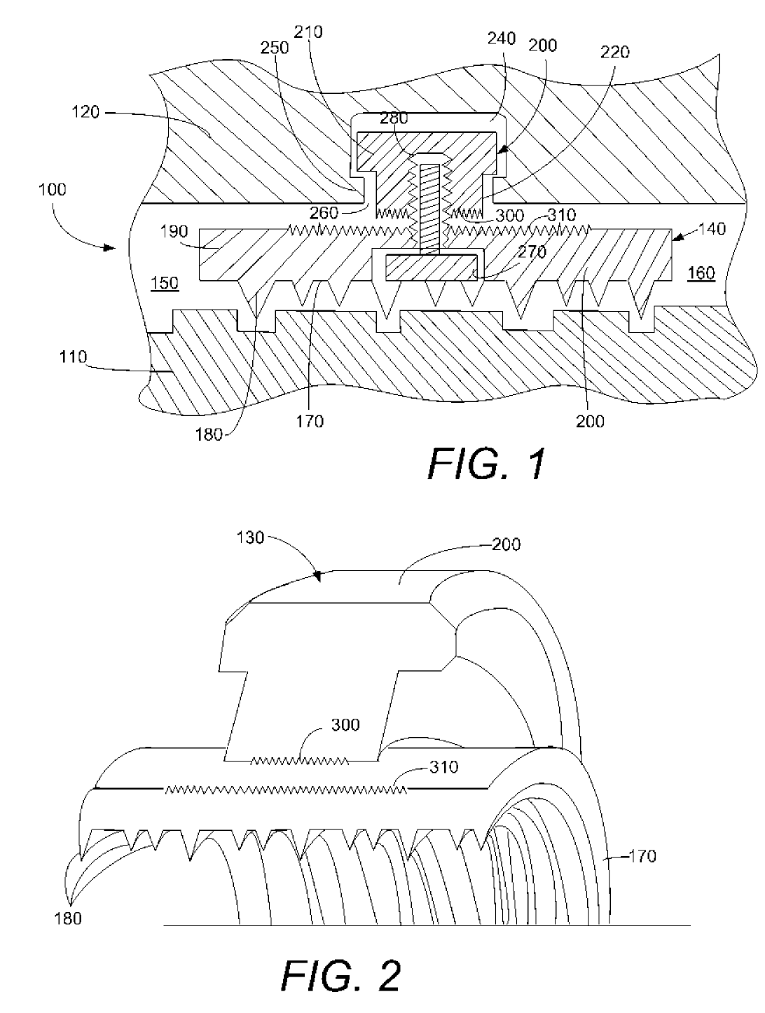

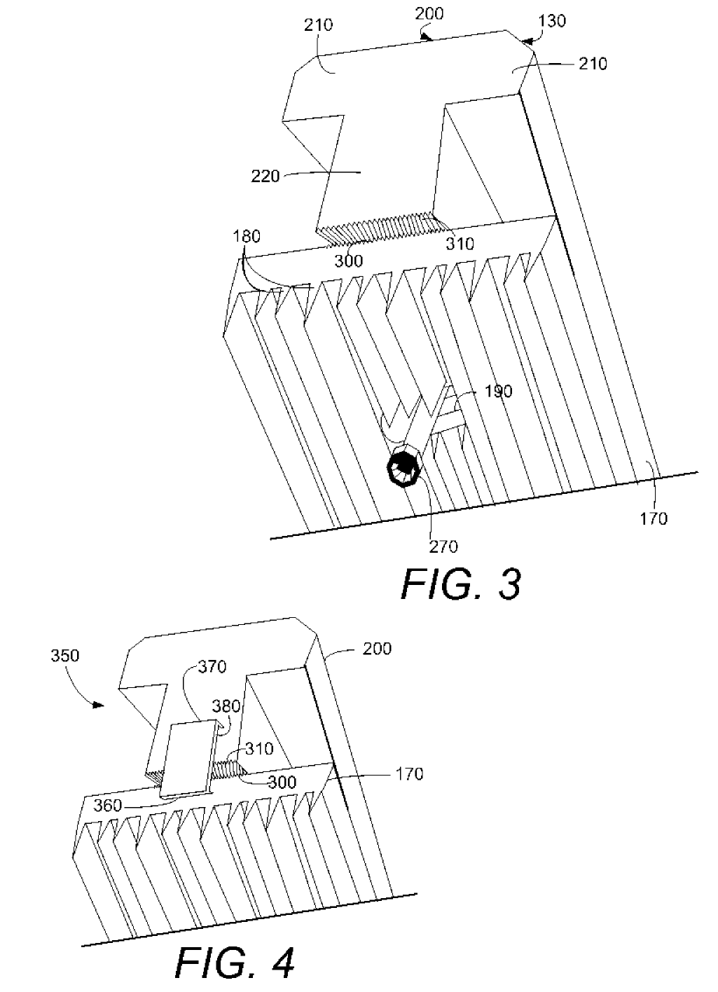

Referring now to the drawings, in which like numerals indicate like elements throughout the several views, FIGS. 1-3 show a portion of a rotary machine, for example, a steam turbine, generally designated 100. The turbine 100 may include a rotary component such as a turbine shaft 110 disposed in a stationary component such as turbine housing 120.

The turbine 100 also may include a number of sealing rings 130. Each sealing ring 130 may have a number of sealing ring segments 140 separating high and low pressure regions on opposite sides of the ring 130, with the high pressure region being denoted at 150 and the low pressure region being denoted at 160. In general, each sealing ring segment 140 functions by placing a relatively large number of partial barriers to the flow of steam from the high pressure region 150 to the low pressure region 160. Each barrier forces steam attempting to flow parallel to the axis of the turbine shaft 110 to follow a tortuous path whereby a pressure drop is created.

Each sealing ring segment 140 includes a sealing face 170, having one or more labyrinth seal teeth 180 spaced one from the other in opposition to the surface of the turbine shaft 110. The number, size, and shape of the seal teeth 180 can be varied as desired. Each sealing face 170 also may have a number of slots 190 positioned therein. The slots 190 may extend in the axial direction. Any number of slots 190 may be used herein.

Each sealing ring segment 140 also has a head portion 200 that mates with the turbine housing 120. The head portion 200 may have a pair of flanges 210 or other means so as to mate with the turbine housing 120. The flanges 210 may extend from a neck portion 220 or a similar type of structure. The head portion 200 may have any desired size or shape.

The stationary component, e.g., the turbine housing 120 generally has a dovetail-shaped annular groove 240 located therein. The turbine housing 120 also may include a pair of flanges 250 for engagement by the flanges 210 so as to retain the sealing ring segment 140 therein. The flanges 250 extend toward one another and define a slot 260 therebetween.

In order to allow the sealing teeth 180 to be adjusted, the present invention connects the head portion 200 to the sealing face 170 using a number of connectors. In this case, bolts 270 may be used. Any desired type of connection means may be used herein. The bolts 270 each may mate with an aperture 280 within the head portion 200. The bolts 270 extend through the slots 190 in the sealing face 170 and into the aperture 280 of the head portion 200.

In order to allow for the very precise movement of the sealing face 170 with respect to the head portion 200, a series of small grooves or threads 300 are machined onto the upper surface of sealing face 170 and a series of small grooves or threads 310 are machined onto the lower surface of the head portion 200. The respective grooves 300, 310 can align with each other. The grooves 300, 310 also may be in the form of a threaded feature. The grooves 300, 310 generally are fine enough so as to prevent any axial leakage flow there through.

In use, the sealing face 170 may be attached to the head portion 200 via the bolts 270 extending through the slot 190 and into the aperture 280 of the head portion 200. The sealing face 170 may be maneuvered axially with respect to the head portion 200 and the turbine shaft 110 due to the length of the slot 190. When the sealing face 170 is in the correct axial position, the bolt 270 may be tightened. The respective grooves 300, 310 help to keep the sealing face 170 in desired position. The grooves 300, 310 act as a type of rack and pinion or vernier arrangement to offer very precise movement in the axial direction. If the grooves 300, 310 are a threaded feature, the pitch of the threads can be varied to achieve the desired level of accuracy with respect to the level of axial adjustment desired.

To the extent that the position of the sealing face 170 needs to be adjusted, the bolts 270 can be loosened and the sealing face 170 can again be properly positioned as desired via the grooves 300, 310. Any position may be used herein.

FIG. 4 shows an alternative embodiment, a packing ring segment 350. The packing ring segment 350 has the sealing face 170 and the head portion 200 as is described above. Instead of or in addition to using the bolt 270 or other type of connection means extending through the slot 190 of the sealing face 170 and the aperture 280 of the head portion 200, this embodiment has a sealing face slot 360 positioned within the sealing face 170 and a head portion slot 370 positioned within the head portion 200. The sealing face slot 370 and the head portion slot 200 then may be connected via a clip 380 extending into the slots 360, 370. The clip 380 may be largely “C” shaped or have any other convenient shape. The slots 360, 370 may have a length in the axial direction of slightly more than the length of the clip 380.

In use, the sealing face 170 and the head portion 200 are aligned with respect to the turbine shaft 110 via the grooves 300, 310 as described above. The clip 380 then may be inserted so as to keep the sealing face 170 and the head portion 200 connected. The clip 380 may be removed as desired so as to realign the packing ring segment 350 as a whole.

It should be apparent that the foregoing relates only to the preferred embodiments of the present invention and that numerous changes and modifications may be made herein without departing from the spirit and scope of the invention as defined by the following claims and the equivalents thereof.

What is claimed is:

1. A sealing ring for a turbine housing, comprising
a sealing face with a plurality of teeth thereon;
an axial slot positioned within the sealing face;
a head portion for positioning within the turbine housing; and
a connector for attaching the sealing face to the head portion through the axial slot.

2. The sealing ring of claim 1, wherein the connector comprises a bolt.

3. The sealing ring of claim 1, wherein the connector comprises a clip.

4. The sealing ring of claim 1, wherein the sealing face comprises a plurality of sealing face grooves.

5. The sealing ring of claim 4, wherein the head portion comprises a plurality of head portion grooves.

6. The sealing ring of claim 5, wherein the plurality of sealing face grooves aligns with the plurality of head portion grooves.

7. The sealing ring of claim 1, further comprising a plurality of axial slots and a plurality of connectors.

8. The sealing ring of claim 1, wherein the sealing face comprises a plurality of axial positions with respect to the head portion.

9. A sealing ring for a turbine housing, comprising
a sealing face with a plurality of teeth thereon;
an axial slot positioned within the sealing face;
a head portion for positioning within the turbine housing; and
a bolt for attaching the sealing face to the head portion through the axial slot;
wherein the sealing face comprises a plurality of axial positions with respect to the head portion.

10. The sealing ring of claim 9, wherein the sealing face comprises a plurality of sealing face grooves.

11. The sealing ring of claim 10, wherein the head portion comprises a plurality of head portion grooves.

12. The sealing ring of claim 11, wherein the plurality of sealing face grooves aligns with the plurality of head portion grooves.

13. The sealing ring of claim 9, further comprising a plurality of axial slots and a plurality of connectors.

14. A method for positioning a sealing ring having a sealing face and a head portion axially with respect to a turbine shaft, comprising:
aligning the sealing face along the turbine shaft;
attaching the sealing face to the head portion; and
rotating the turbine shaft such that the sealing face does not contact the turbine shaft.

15. The method of claim 14, wherein the attaching step comprises inserting a bolt through the sealing face and the head portion.

16. The method of claim 14, wherein the attaching step comprises inserting a clip into the sealing face and the head portion.
